(19) United States
(12) Patent Application Publication
(10) Pub. No.: US 2025/0269741 A1
(43) Pub. Date: Aug. 28, 2025

(54) POWER STORAGE DEVICE AND VEHICLE

(71) Applicant: TOYOTA JIDOSHA KABUSHIKI KAISHA, Aichi-ken (JP)

(72) Inventor: Shinya GOITSUKA, Nisshin-shi (JP)

(21) Appl. No.: 19/021,171

(22) Filed: Jan. 15, 2025

(30) Foreign Application Priority Data
Feb. 26, 2024 (JP) 2024-026639

(51) Int. Cl. B60L 50/64; B60K 1/04; B60L 50/60

(52) U.S. Cl. CPC B60L 50/64; B60K 1/04; B60L 50/66; B60K 2001/0438

(57) ABSTRACT

A power storage device includes: a power storage module including a plurality of power storage cells; and a case accommodating the power storage module. The case includes an upper cover covering the power storage module from above and a lower cover covering the power storage module from below. The power storage module is secured to the upper cover. The lower cover is detachably secured to the upper cover.

### CROSS REFERENCE TO RELATED APPLICATIONS

This nonprovisional application is based on Japanese Patent Application No. 2024-026639 filed on Feb. 26, 2024 with the Japan Patent Office, the entire content of which is hereby incorporated by reference.

### BACKGROUND

### Field

The present disclosure relates to a power storage device and a vehicle.

### Description of the Background Art

Japanese Patent Laying-Open No. 2023-046945 discloses the battery pack accommodating multiple battery modules. The battery case, which is the outer shell of the battery pack, is configured of an upper case and a lower case. The battery module is mounted on the lower case.

### SUMMARY

Since the battery module is mounted on the lower case as noted above, the repair of the lower case (lower cover) is poorly workable.

The present disclosure is made to solve the above problem, and an object of the present disclosure is to provide a power storage device whose lower cover of the case is readily removable and a vehicle.

A power storage device according to a first aspect of the present disclosure includes a power storage module including a plurality of power storage cells, and a case accommodating the power storage module. The case includes a first cover covering the power storage module from above and a second cover covering the power storage module from below. The power storage module is secured to the first cover. The second cover is detachably secured to the first cover. Note that “detachably securing” refers to securing objects in a manner that they are non-destructively detachable. “Non-detachably securing,” in contrast, refers to securing objects in a manner that at least one of the objects is destructed when separating them from each other (e.g., the surface is delaminated).

In the power storage device according to the first aspect of the present disclosure, the power storage module is secured to the first cover and the second cover is detachably secured to the first cover, as noted above. Owing to this, since the power storage module remains secured to the first cover even if the second cover is removed from the first cover, the power storage module can be prevented from being removed from the first cover, together with the second cover. This allows the second cover to be readily removed from the first cover.

The power storage device may further include a third cover below the second cover. The second cover may have higher rigidity than the third cover. With such a configuration, the third cover can prevent the second cover from being damaged by a foreign object flew from below the power storage module. Moreover, since the second cover has higher rigidity than the third cover, the second cover can further be prevented from being damaged than when the rigidity of the second cover is less than or equal to the rigidity of the third cover.

The third cover may be detachably secured to the second cover from below. With such a configuration, the third cover can be removed from the second cover when the third cover is damaged, for example.

In the region where the case overlaps with the power storage module in the up-down direction, the distance in the up-down direction between the second cover and the third cover is less than the distance in the up-down direction between the second cover and the power storage module. With such a configuration, the height of the power storage device in the up-down direction can be reduced, as compared to when the distance in the up-down direction between the second cover and the third cover is greater than or equal to the distance in the up-down direction between the second cover and the power storage module. Moreover, since the distance in the up-down direction between the second cover and the power storage module is great, the evacuation pathway for the smoke evacuated downward from the power storage module can be readily ensured and the power storage module can be protected from the interference (the impact) from below.

The first cover may include: a top panel above the power storage module; and a securing unit on the top panel. The power storage module may be secured to the securing unit, and the second cover may be secured to the securing unit from below. With such a configuration, a reduced stress can be applied to the top panel, as compared to the second cover being secured directly to the top panel.

The securing unit may extend downward from the top panel. With such a configuration, the second cover and the securing unit below the top panel can be readily joined together.

The power storage device may further include: a frame member surrounding the securing unit and the power storage module; and a sealing member sealing between the frame member and the second cover. The first cover and the second cover may be secured to the frame member. The sealing member may be disposed in a vicinity where the second cover is secured to the frame member. With such a configuration, the sealing member can inhibit ingress of water or the like from between the second cover and the frame member. Note that surrounding the securing unit and the power storage module includes not only surrounding the securing unit and the power storage module circumferentially, but also sandwiching the securing unit and the power storage module in a predetermined direction. The vicinity includes not only the target location, but also near the target location.

The second cover may be secured to the frame member below the power storage module. With such a configuration, the second cover can be inhibited from interfering with the power storage module when the second cover is removed (demounted downward).

The power storage device may further include a fastener member fastening the second cover and the securing unit. The second cover may include: a cover body; and an extending ridge receding upward from the cover body. The fastener member may fasten the extending ridge and the securing unit. With such a configuration, the second cover has an increased mechanical strength, as compared to the second cover with no extending ridge. Moreover, since the fastening point between the fastener member and the extending ridge is at the extending ridge, the fastening point can be formed upward, as compared to the second cover with no extending ridge. As a result, the fastener member can be protected from the impact of the interference from below (interfered from below).

The fastener member may be disposed so as to have a lower end located at the same position as or above an undersurface of the cover body in the up-down direction. With such a configuration, the fastener member can be more protected from the impact of the interference from below (interfered from below).

The second cover may have higher rigidity than the first cover. With such a configuration, damage to (breakage of) the second cover can be inhibited, as compared to the second cover having lower rigidity than the first cover.

In the region where the case overlaps with the power storage module in the up-down direction, the distance in the up-down direction between the first cover and the power storage module may be less than the distance in the up-down direction between the second cover and the power storage module. With such a configuration, the height of the power storage device in the up-down direction can be reduced, as compared to when the distance in the up-down direction between the first cover and the power storage module is greater than or equal to the distance in the up-down direction between the second cover and the power storage module. Moreover, since the distance in the up-down direction between the second cover and the power storage module is comparatively great, the evacuation pathway for the smoke evacuated downward from the power storage module can be readily ensured and the interference (the impact) can be prevented from being input to the power storage module from below.

A vehicle according to a second aspect of the present disclosure includes a vehicle body and the power storage device according to the first aspect secured to the bottom of the vehicle body. This can provide the vehicle whose second cover can be readily removed from the vehicle body (the power storage device).

The foregoing and other objects, features, aspects and advantages of the present disclosure will become more apparent from the following detailed description of the present disclosure when taken in conjunction with the accompanying drawings. The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a vehicle having a power storage device according to one embodiment mounted thereon.

FIG. 2 is a cross-sectional view of the power storage device according to the embodiment, as viewed from above.

FIG. 3 is a cross-sectional view of the power storage device of FIG. 2, taken along a III-III line.

FIG. 4 is a schematic view showing a configuration of an upper cross.

FIG. 5 is an enlarged partial view of the power storage device in the vicinity of the upper cross and lower cross of FIG. 3.

FIG. 6 is a cross-sectional view of the power storage device of FIG. 2, taken along a VI-VI line.

FIG. 7 is an enlarged partial view of the power storage device in the vicinity of the power storage module of FIG. 2.

FIG. 8 is an enlarged partial view of the power storage device in the vicinity of the upper cross and lower cross of FIG. 6.

FIG. 9 is a flow diagram illustrating a method of removal of the lower cover from the power storage device according to the embodiment.

FIG. 10 is a cross-sectional view of the power storage device in step S4 of FIG. 9.

FIG. 11 is a cross-sectional view of the power storage device in step S5 of FIG. 9.

FIG. 12 is a cross-sectional view of the power storage device in step S6 of FIG. 9.

FIG. 13 is a cross-sectional view of a configuration of the power storage device according to Variation 1 of the embodiment, as viewed from above.

FIG. 14 is a partially enlarged, cross-sectional view of a configuration of the power storage device in the vicinity of the bottom of the lower cover according to Variation 2 of the embodiment.

### DESCRIPTION OF THE PREFERRED EMBODIMENTS

Embodiments according to the present disclosure will be described, with reference to the accompanying drawings. Referring now to the drawings wherein like numerals are used to refer to like or corresponding members.

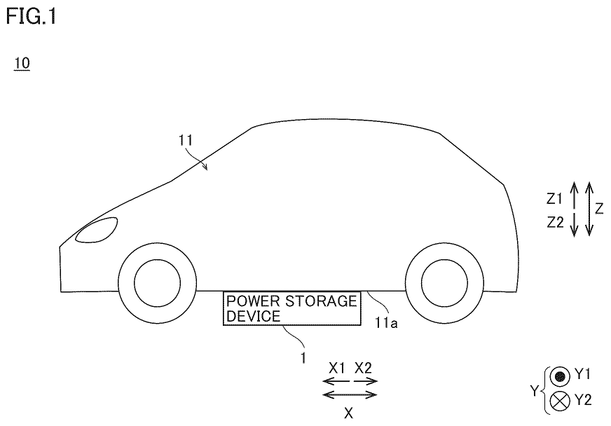

FIG. 1 is a diagram showing a vehicle 10 having a power storage device 1 according to an embodiment of the present disclosure mounted thereon. Power storage device 1 is a device for storing power for driving vehicle 10. Vehicle 10 includes, for example, a plug-in hybrid electric vehicle (PHEV), a battery electric vehicle (BEV), or a fuel cell electric vehicle (FCEV).

X direction, Y direction, Z direction, as used herein, are directions that are orthogonal to one another. For example, X direction and Y direction may be the front-rear direction and the left-right direction, respectively, of vehicle 10. Z direction may be the up-down (vertical) direction. Note that Z direction is one example of a up-down direction according to the present disclosure. A Z1 side and a Z2 side are one example of “above” and “below,” respectively, according to the present disclosure.

Besides power storage device 1, vehicle 10 includes a vehicle body 11. Vehicle body 11 has an under body 11a. Under body 11a is disposed on the lower part (the bottom) of vehicle body 11. Power storage device 1 is disposed on under body 11a. Specifically, power storage device 1 is secured (fastened) to under body 11a below under body 11a. Note that under body 11a is one example of a “bottom” according to the present disclosure.

### <Configuration of Power Storage Device>

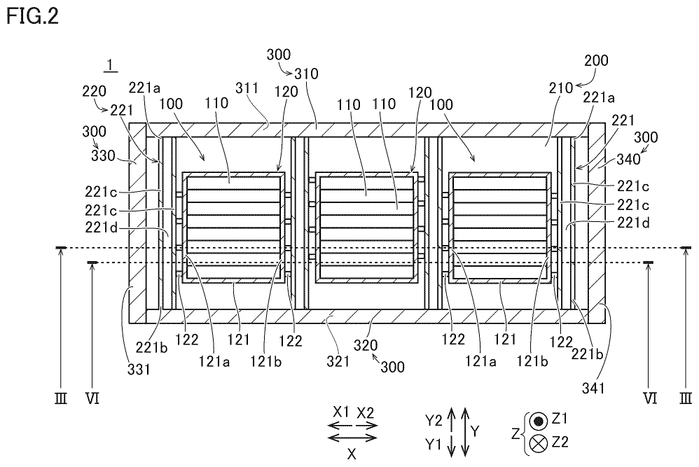

Referring to FIG. 2, power storage device 1 includes a power storage module 100, a case 200, and a frame 300. Case 200 accommodates power storage module 100. Note that frame 300 is one example of a “frame member” according to the present disclosure.

As shown in FIG. 2, multiple (three, in the present embodiment) power storage modules 100 are provided in power storage device 1. Power storage modules 100 are aligned in X direction. Note that the number of power storage modules 100 included in power storage device 1 may be other than three (e.g., one).

Power storage modules 100 each include multiple power storage cells 110 and a module case 120. Note that module case 120 is formed from a metal such as aluminum, for example.

In each of power storage modules 100, multiple power storage cells 110 are accommodated in module case 120. Power storage cells 110 of each power storage module 100 are aligned (stacked) in Y direction. Power storage cells 110 each have a cuboid shape elongated in X direction. Specifically, the power storage cell 110 is formed to have the length in X direction greater than the length in Y direction and the height in Z direction. Note that each power storage cell 110 may be disposed to have the longitudinal direction in Y direction.

Module case 120 of each power storage module 100 includes a case body 121 and multiple (eight, in the present embodiment) connections 122. Case body 121 has a hollow cuboid shape accommodating power storage cells 110.

Connections 122 are disposed extending in X direction from case body 121. Specifically, four of the eight connections 122 project from a side 121a of case body 121 to the X1 side. The remaining four of the eight connections 122 project to the X2 side from a side 121b of case body 121 on the X2 side.

The four connections 122 of side 121a and the four connections 122 of side 121b are disposed at the same position in Y direction. Four connections 122 are equidistantly disposed on each of side 121a and side 121b. Note that the eight connections 122 are disposed at the same height in Z direction.

Power storage modules 100 that are adjacent to each other in X direction are disposed so that their orientations are rotated 180 degrees to each other in Y direction. This displaces the positions of connections 122 in Y direction between power storage modules 100 adjacent to each other in X direction.

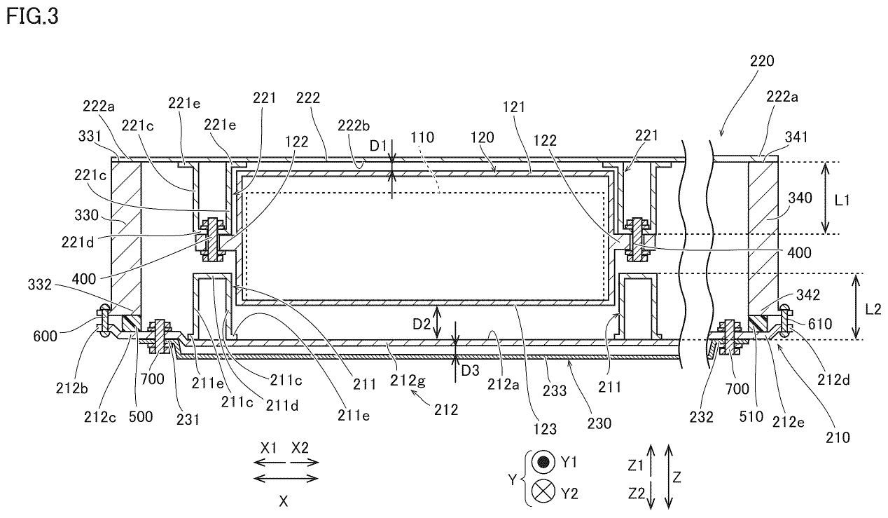

Referring to FIG. 3, case 200 includes a lower cover 210, an upper cover 220, and a share panel 230 (FIG. 3). Lower cover 210, upper cover 220, and share panel 230 are each formed from a metal (e.g., iron). Note that upper cover 220 and lower cover 210 are one example of a “first cover” and a “second cover,” respectively, according to the present disclosure. Share panel 230 is one example of a “third cover” according to the present disclosure.

Lower cover 210 is located on the Z2 side of power storage modules 100 to cover power storage modules 100 from the Z2 side. Lower cover 210 extends in X direction across power storage modules 100.

Upper cover 220 includes upper crosses 221. Upper cover 220 includes multiple (four, in the present embodiment) upper crosses 221. Upper crosses 221 extend in Y direction. Upper crosses 221 are aligned in X direction. Specifically, upper crosses 221 are equidistantly disposed in X direction. Power storage modules 100 are each disposed between upper crosses 221 aligned in X direction. Note that upper cross 221 is one example of a “securing unit” according to the present disclosure.

Upper cross 221 has a Y2-side end 221a joined (e.g., welded) to a wall 310 (described below) of frame 300. Upper cross 221 has a Y1-side end 221b joined (e.g., welded) to a wall 320 (described below) of frame 300.

Upper cross 221 includes a pair of sides 221c and a bottom 221d. The pair of sides 221c extend in Z direction. The pair of sides 221c also extend in Y direction. In other words, the pair of sides 221c extend orthogonal to X direction. The pair of sides 221c are disposed opposing to each other in X direction.

Bottom 221d connects the lower ends of the pair of sides 221c (FIG. 3). Bottom 221d extends in X direction. Bottom 221d also extends in Y direction. In other words, bottom 221d extends orthogonal to Z direction. Note that, the pair of sides 221c of upper cross 221 are orthogonal to bottom 221d.

A cavity extending in Y direction is formed between the pair of sides 221c (on the Z1 side of bottom 221d). In other words, upper cross 221 has a hollow shape.

Frame 300, as viewed from the Z1 side, surrounds power storage modules 100. In other words, frame 300 is formed in a rectangular frame shape as viewed from the Z1 side. Frame 300 extends in Z direction. In other words, frame 300 has a hollow rectangular cylindrical shape extending in Z direction.

Frame 300 includes wall 310, wall 320, a wall 330, and a wall 340. Wall 310 and wall 320 extend orthogonal to Y direction. Wall 330 and wall 340 extend orthogonal to X direction.

Wall 310 covers power storage modules 100 and upper crosses 221 from the Y2 side. Wall 320 covers power storage modules 100 and upper crosses 221 from the Y1 side. Wall 310 and wall 320 extend in X direction across power storage modules 100 and upper crosses 221 that are aligned in X direction. Power storage modules 100 and upper crosses 221 are sandwiched in Y direction between wall 310 and wall 320.

Wall 330 covers power storage module 100 that is the closest to the X1 side, among power storage modules 100, from the X1 side. Wall 330 is disposed further away from power storage module 100 than upper cross 221 closest to the X1 side among upper crosses 221.

Wall 340 covers from the X2 side, power storage module 100 closest to the X2 side, among power storage modules 100. Wall 340 is disposed further away from power storage module 100 than upper cross 221 closest to the X2 side among upper crosses 221.

Power storage modules 100 and upper crosses 221 are sandwiched in X direction between wall 330 and wall 340.

Wall 310 is connected to wall 330 and wall 340. Specifically, wall 310 has the X1-side end connected to the Y2-side end of wall 330. Wall 310 has the X2-side end connected to the Y2-side end of wall 340.

Wall 320 is connected to wall 330 and wall 340. Specifically, wall 320 has the X1-side end connected to the Y1-side end of wall 330. Wall 320 has the X2-side end connected to the Y1-side end of wall 340.

Note that the walls 310 to 340 are joined together by welding (such as arc welding), for example.

Walls 310, 320, 330, and 340 have an upper end surface 311, an upper end surface 321, an upper end surface 331, and an upper end surface 341, respectively. Upper end surface 311, upper end surface 321, upper end surface 331, and upper end surface 341 are provided on the upper ends of wall 310, wall 320, wall 330, and wall 340, respectively.

Upper end surface 311, upper end surface 321, upper end surface 331, and upper end surface 341 are joined to an outer periphery 222a (FIG. 3) of upper cover 220. Upper end surface 311, upper end surface 321, upper end surface 331, and upper end surface 341 are joined to outer periphery 222a by friction stir welding (FSW).

FIG. 3 is a cross-sectional view of the power storage device at a position in Y direction where connections 122 are disposed. As shown in FIG. 3, upper cover 220 covers power storage modules 100 from the Z2 side. Specifically, upper cover 220 includes a top panel 222 located on the Z1 side of power storage modules 100. Top panel 222 extends in X direction across power storage modules 100. A portion (an end in X direction) of top panel 222 projects in X direction to the X1 side and the X2 side from the region where power storage modules 100 are disposed. Top panel 222 extends orthogonal to Z direction.

Upper crosses 221 are disposed on top panel 222. Specifically, upper crosses 221 are secured to the power storage module 100-side (the Z2-side) surface 222b of top panel 222 by welding, for example.

Upper crosses 221 extend downward from top panel 222.

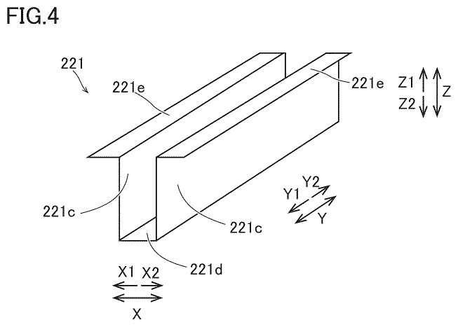

Upper crosses 221 include a pair of upper ends 221e which are secured to surface 222b of top panel 222. One of the pair of upper ends 221e is connected to one of the pair of sides 221c. The other one of the pair of upper ends 221e is connected to the other one of the pair of sides 221c. Side 221c and upper end 221e connected to each other are orthogonal to each other. The pair of upper ends 221e extends in directions away from each other, from points of connection with side 221c. The pair of upper ends 221e also extend in Y direction (FIG. 4). In other words, the pair of upper ends 221e extend orthogonal to Z direction. Note that upper cross 221 has a downwardly convex shape (a hat shape).

The pair of upper ends 221e are each integrally formed with side 221c. The pair of sides 221c are each integrally formed with bottom 221d. In other words, upper cross 221 is formed by one metal plate being folded several times. This enhances the rigidity of upper cross 221 greater than the rigidity of top panel 222.

Here, in a conventional power storage device, since the power storage modules are disposed (mounted) on the lower cover, removal of the lower cover for repair requires removal of the power storage modules.

Thus, in the present embodiment, power storage modules 100 are secured to upper cover 220. This allows power storage modules 100 to be held by upper cover 220 even when lower cover 210 is removed.

Specifically, connections 122 of module case 120 are secured to upper cross 221. Connections 122 are secured from below to bottom 221d of upper cross 221. Specifically, bottom 221d of upper cross 221 and connections 122 of module case 120 are fastened by bolts 400.

Lower cover 210 includes multiple lower crosses 211 and a bottom plate 212. Bottom plate 212 is located on the Z2 side of power storage modules 100. Bottom plate 212 covers power storage modules 100 from the Z2 side. Bottom plate 212 extends in X direction across power storage modules 100. A portion (an end in X direction) of bottom plate 212 projects in X direction to the X1 side and the X2 side from the region where power storage modules 100 are disposed.

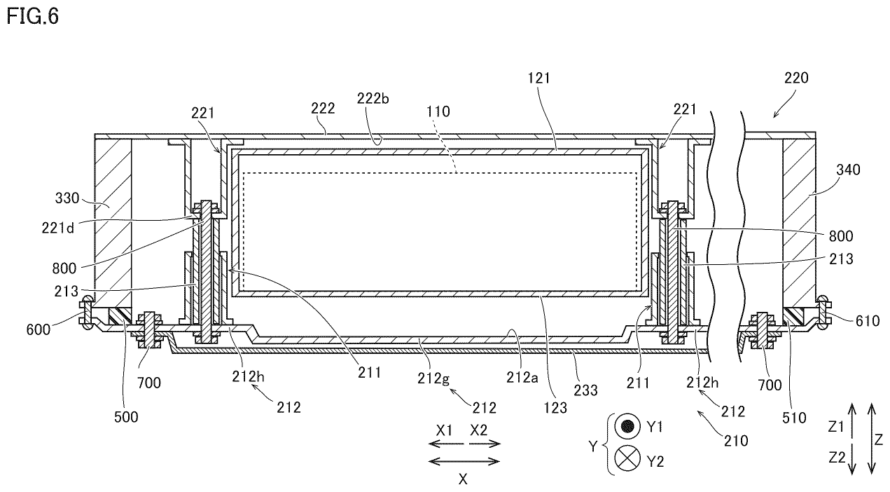

Lower crosses 211 are disposed on bottom plate 212. Specifically, lower crosses 211 are secured to a power storage module 100-side (Z1-side) surface 212a of bottom plate 212 by welding, for example. Lower cross 211 extends from bottom plate 212 to the Z1 side. Note that while bottom plate 212 includes a bottom 212g and an extending ridge 212h (FIG. 6) described below, the cross section shown in FIG. 3 does not show extending ridge 212h, showing only bottom 212g. Accordingly, bottom plate 212 in the description with respect to FIG. 3 refers to bottom 212g.

Lower cross 211 has a similar shape to upper cross 221. Lower cross 211 has a shape of a vertically inverted upper cross 221. In other words, lower cross 211 has a shape bulging upward (a hat shape).

Specifically, lower cross 211 has a pair of sides 211c corresponding to the pair of sides 221c of upper cross 221. Lower cross 211 has an upper surface 211d corresponding to bottom 221d of upper cross 221. Lower cross 211 has a pair of lower ends 211 corresponding to the pair of upper ends 221e of upper cross 221.

Specifically, the pair of sides 211c extend in Z direction. The pair of sides 211c extend in Y direction. In other words, the pair of sides 211c extend orthogonal to X direction. The pair of sides 211c oppose to each other in X direction.

Upper surface 211d connects the top ends of the pair of sides 211c (FIG. 3). Upper surface 211d extends in X direction. Upper surface 211d also extends in Y direction. In other words, upper surface 211d extends in a direction orthogonal to Z direction. Note that, in lower cross 211, the pair of sides 211c are orthogonal to upper surface 211d.

A cavity extending in Y direction is formed between the pair of sides 211c (on the Z2 side of upper surface 211d). In other words, lower cross 211 has a hollow shape.

The pair of lower ends 211e are secured to surface 212a of bottom plate 212. One of the pair of lower ends 211e is connected to one of the pair of sides 211c. The other one of the pair of lower ends 211e is connected to the other one of the pair of sides 211c. Side 211c and lower end 211e connected to each other are orthogonal to each other. The pair of lower ends 211e extend in directions away from each other, from points of connection with side 211c.

The pair of lower ends 211e are each integrally formed with side 211c. The pair of sides 211c are each integrally formed with upper surface 211d. In other words, as with upper cross 221, lower cross 211 is formed by one metal plate being folded several times.

Lower crosses 211 overlap upper crosses 221 in Z direction. In other words, lower crosses 211 are disposed below the four upper crosses 221.

In the region where case 200 overlaps with the multiple power storage modules 100 in the up-down direction, a distance D1 in Z direction between upper cover 220 (top panel 222) and power storage modules 100 is less than a distance D2 in Z direction between lower cover 210 (bottom plate 212) and power storage modules 100.

Note that power storage module 100 is configured to evacuate smoke to the Z2 side. In other words, the space from which smoke is evacuated (a space in power storage module 100 on the Z2 side) is greater than an opposing space (a space in power storage module 100 on the Z1 side).

Upper cross 221 has a length L1 in Z direction. Lower cross 211 has a length L2 in Z direction. Length L2 is less than length L1. This reduces the size of lower cover 210, thereby enabling lower cover 210 to be readily exchanged. Note that length L2 may be greater than or equal to length L1.

Power storage device 1 includes a sealing member 500 and a sealing member 510. Sealing member 500 is provided separately from sealing member 510. Sealing members 500 and 510 may be, for example, urethane seals. Sealing members 500 and 510 may have adhesion properties.

Sealing member 500 is disposed to seal a gap between a lower end 332 of wall 330 and an X1-side portion 212c of bottom plate 212 of lower cover 210 in the vicinity of an outer periphery 212b. Note that, while not shown, sealing member 500 extends in Y direction along wall 330.

Sealing member 510 is disposed to seal a gap between a lower end 342 of wall 340 and an X2--side portion 212e of bottom plate 212 of lower cover 210 in the vicinity of an outer periphery 212d. Note that, while not shown, sealing member 510 extends in Y direction along wall 340.

Sealing members 500 and 510 allow bottom plate 212 of lower cover 210 to be adhered (secured) to walls 330 and 340. Note that sealing members may also be provided between bottom plate 212 and wall 310 and between bottom plate 212 and wall 320.

Power storage device 1 includes a rivet 600 and a rivet 610. Rivet 600 secures lower end 332 of wall 330 and outer periphery 212b of lower cover 210. In other words, sealing member 500 is disposed in the vicinity where lower end 332 and outer periphery 212b are secured by rivet 600. Rivet 600 is disposed on the X1 side of sealing member 500 (opposite the power storage module 100 relative to sealing member 500). Note that multiple rivets 600 may be alighted in Y direction along wall 330.

Rivet 610 secures lower end 342 of wall 340 and outer periphery 212d of lower cover 210. In other words, sealing member 510 is disposed in the vicinity where lower end 342 and outer periphery 212d are secured by rivet 610. Rivet 610 is disposed on the X2 side of sealing member 510 (opposite the power storage module 100 relative to sealing member 510). Note that multiple rivets 610 may be alighted in Y direction along wall 340.

Bottom plate 212 of lower cover 210 is secured to wall 330 and wall 340 on the Z2 side of power storage modules 100. In other words, outer peripheries 212b and 212d of bottom plate 212 are located on the Z2 side of the bottom 123 of module case 120. Note that the bottom 123 is the Z2 side end of module case 120.

Portions 212c and 212e of bottom plate 212 are also located on the Z2 side of the bottom 123 of module case 120.

Outer peripheries 212b and 212d are disposed on the Z1 side of portions 212c and 212e. In other words, a step is formed between outer periphery 212b and portion 212c and between outer periphery 212d and portion 212e. Note that outer peripheries 212b and 212d may be disposed at the same location as the portions 212c and 212e in Z direction or disposed at on the Z2 side of portions 212c and 212e in Z direction.

Share panel 230 is disposed below lower cover 210. Share panel 230 covers bottom plate 212 of lower cover 210 from below.

Share panel 230 is detachably secured to lower cover 210 from the Z2 side. Specifically, share panel 230 is fastened to bottom plate 212 of lower cover 210 with bolts 700. Bolts 700 fasten bottom plate 212 to an X1-side end 231 of share panel 230 and an X2-side end 232 of share panel 230. Note that multiple bolts 700 may be alighted in Y direction at each of end 231 and end 232. Note that “detachably securing” refers to securing objects in a manner that they are non-destructively detachable. “Non-detachably securing,” in contrast, refers to securing (e.g., securing by welding) objects in a manner that at least one of the objects is destructed when separating them from each other (e.g., the surface is delaminated).

Note that “detachably securing” refers to securing objects in a manner that they are non-destructively detachable. For example, objects, while they are adhered to each other with an adhesive, can be detached from each other by fracturing the adhered portion. Thus, the adhering corresponds to “detachably securing.” Securing objects by fastener member with bolts and nuts can also detach the objects from each other by loosening the bolts and nuts. Thus, fastening with bolts and nuts corresponds to “detachably securing.”

“Non-detachably securing,” in contrast, refers to securing objects in a manner that at least one of the objects is destructed when separating them from each other (e.g., the surface is delaminated) (e.g., securing by welding). Note that welded portion has continuity at molecular level of the metal members welded together, and is significantly different from “detachably securing” noted above.

Bolts 700 are provided on the X1 side of lower cross 211 closest to the X1 side, among lower crosses 211, and on the X2 side of lower cross 211 closest to the X2 side, among lower crosses 211.

Share panel 230 includes a concave portion 233. Concave portion 233 is connected to ends 231 and 232. Concave portion 233 is disposed between ends 231 and 232 in X direction. Concave portion 233 is formed to project inwardly (recede) to the Z2 side from ends 231 and 232.

In the region where case 200 overlaps with power storage module 100 in Z direction, a distance D3 in Z direction between bottom plate 212 of lower cover 210 and concave portion 233 of share panel 230 is less than distance D2 in Z direction between bottom plate 212 and power storage module 100. For example, distance D3 may be half the distance D2 or less.

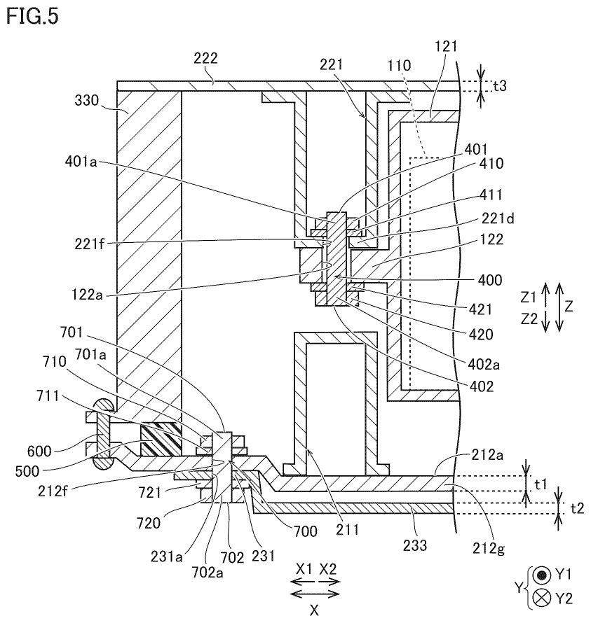

FIG. 5 is an enlarged partial view of the power storage device in the vicinity of wall 330 of FIG. 3. Note that the wall 340 side has the same configuration as that of FIG. 5, and the description thereof will, thus, not be repeated.

A through-hole 122a, through which the bolt 400 passes in Z direction, is formed in connection 122. A through-hole 221f, through which the bolt 400 passes in Z direction, is formed in bottom 221d of upper cross 221. Through-holes 122a and 221f overlap in Z direction.

Bolt 400 is fastened to a nut 410 and a nut 420. Nut 410 is fastened to a portion 401a of bolt 400 in the vicinity of a Z1-side end 401 of bolt 400. Nut 410 is secured (welded) to bottom 221d of upper cross 221 from the Z1 side. Note that a washer 411 is disposed between nut 410 and bottom 221d.

Nut 420 is fastened to a portion 402a of bolt 400 in the vicinity of a Z2-side end 402 of bolt 400. Nut 420 is secured to connection 122 from the Z2 side. Note that a washer 421 is disposed between nut 420 and connection 122.

A through-hole 231a, through which the bolt 700 passes in Z direction, is formed in end 231 of share panel 230. A through-hole 212f, through which the bolt 700 passes in Z direction, is formed in bottom plate 212 of lower cover 210. Through-holes 231a and 212f overlap in Z direction.

Bolt 700 is fastened to a nut 710 and a nut 720. Nut 710 is fastened to a portion 701a of bolt 700 in the vicinity of a Z1-side end 701. Nut 710 is secured (welded) to surface 212a of bottom plate 212. Note that a washer 711 is disposed between nut 710 and surface 212a.

Nut 720 is fastened to a portion 702a of bolt 700 in the vicinity of the Z2-side end 702 of bolt 700. Nut 720 is secured to end 231 of share panel 230 from the Z2 side. Note that a washer 721 is disposed between nut 720 and end 231.

In the present embodiment, lower cover 210 (bottom plate 212) has greater rigidity than share panel 230. Specifically, a thickness t1 of bottom plate 212 in Z direction is greater than a thickness t2 of share panel 230 in Z direction. Note that the rigidity may include flexural rigidity, for example.

Lower cover 210 (bottom plate 212) has greater rigidity than upper cover 220 (top panel 222). Specifically, thickness t1 of bottom plate 212 in Z direction is greater than a thickness t3 of top panel 222 in Z direction.

FIG. 6 is a cross-sectional view of the power storage device at a position in Y direction different from FIG. 3. Specifically, FIG. 6 is a cross-sectional view of the power storage device at a position in Y direction where connections 122 are not provided.

As shown in FIG. 6, lower cover 210 is detachably secured to upper cover 220. Specifically, lower cover 210 is secured to upper cross 221 from the Z2 side.

Power storage device 1 includes bolts 800. Bolts 800 fasten bottom plate 212 of lower cover 210 and upper cross 221 (bottom 221d). In other words, bottom plate 212 is indirectly secured to top panel 222 with bolts 800. Note that bolt 800 is one example of a “fastener member” according to the present disclosure.

Lower cover 210 is provided with a collar member 213. Collar member 213 extends in Z direction to guide bolt 800 from bottom plate 212 of lower cover 210 to upper cross 221. Collar member 213 is secured to bottom plate 212 (surface 212a) from the Z1 side by welding, for example.

Bottom plate 212 of lower cover 210 includes a bottom 212g and an extending ridge 212h. Bolt 800 fastens extending ridge 212h and upper cross 221. Note that bottom 212g is one example of a “cover body” according to the present disclosure.

Extending ridge 212h is formed to recede upward from bottom 212g. In other words, a step is formed between extending ridge 212h and bottom 212g. In the cross section shown in FIG. 6, bottom 212g is disposed between extending ridges 212h in X direction.

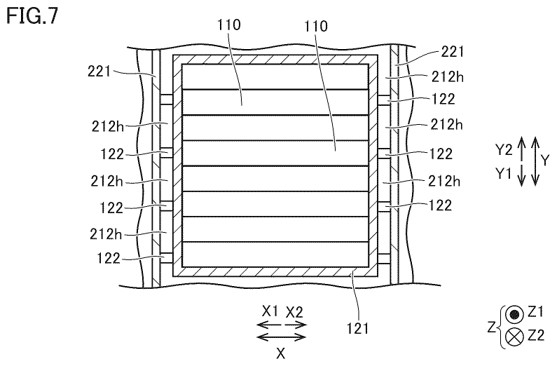

Note that, as shown in FIG. 7, connections 122 of power storage module 100 and extending ridges 212h of lower cover 210 are alternately disposed in Y direction. Multiple extending ridges 212h are aligned in Y direction Extending ridges 212h are arranged equidistantly in Y direction on the Z2 side of lower cross 211.

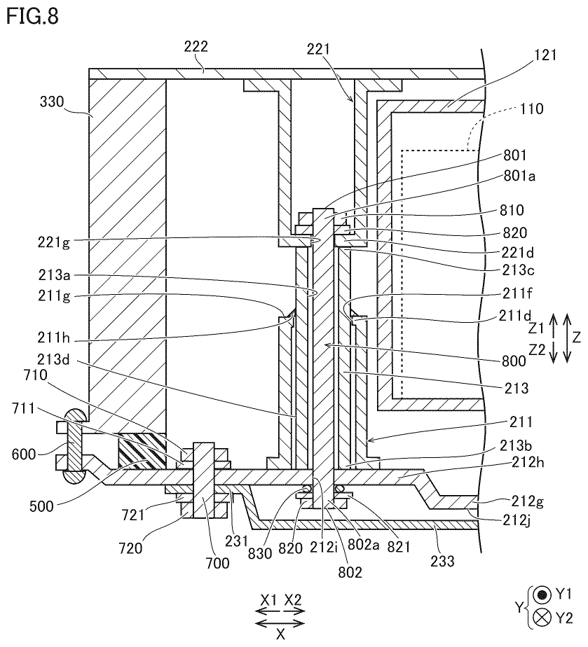

FIG. 8 is an enlarged partial view of the power storage device in the vicinity of wall 330 of FIG. 6. Note that the wall 340 side has the same configuration as that of FIG. 8, and the description thereof will, thus, not be repeated.

A through-hole 221g, through which the bolt 800 passes in Z direction, is formed in bottom 221d of upper cross 221.

A through-hole 212i, through which the bolt 800 passes in Z direction, is formed in extending ridge 212h of lower cover 210.

A through-hole 211f, through which the bolt 800 passes in Z direction, is formed in upper surface 211d of lower cross 211.

Through-holes 221g, 212i, and 211f overlap in Z direction. Bolt 800 passes through through-holes 221g, 212i, and 211f, thereby extending from the Z2 side of extending ridge 212h to the Z1 side of bottom 221d of upper cross 221.

Bolt 800 is fastened to nut 810 and nut 820. Nut 810 is fastened to a portion 801a of bolt 800 in the vicinity of a Z1-side end 801 of bolt 800. Nut 810 is secured (welded) to bottom 221d of upper cross 221 from the Z1 side. Note that a washer 811 is disposed between nut 810 and bottom 221d. Note that nut 820 is one example of a “fastener member” according to the present disclosure.

Nut 820 is fastened to a portion 802a of bolt 800 in the vicinity of a Z2-side end 802 of bolt 800. Nut 820 is secured to extending ridge 212h from the Z2 side. Note that a washer 821 is disposed between nut 820 and extending ridge 212h. Washer 821 is one example of a “fastener member” according to the present disclosure.

Note that nut 820 and washer 821 are accommodated in a space formed between bottom plate 212 of lower cover 210 and share panel 230.

An annular sealing member 830 (e.g., rubber, etc.) is disposed between washer 821 and extending ridge 212h. Sealing member 830 is sandwiched between washer 821 and extending ridge 212h in Z direction. Bolt 800 passes through sealing member 830.

End 802 of bolt 800 is disposed at the same position in Z direction as an undersurface 212j of bottom 212g of lower cover 210. Note that, in the present embodiment, end 802 of bolt 800 is disposed at the same position in Z direction as the undersurface (no reference sign attached) of nut 820.

Collar member 213 has a through-hole 213a through which the bolt 800 passes in Z direction. Collar member 213 extends in Z direction. For example, collar member 213 has a cylindrical shape. Note that the shape of collar member 213 may be other than the cylindrical shape (e.g., a rectangular cylindrical shape). Collar member 213 is configured of a metal such as aluminum. Note that collar member 213 may be formed of a resin, for example.

A lower end 213b of collar member 213 is in contact with extending ridge 212h of lower cover 210. An upper end 213c of collar member 213 is in contact with bottom 221d of upper cross 221. Collar member 213 extends from extending ridge 212h of lower cover 210 to bottom 221d of upper cross 221, passing through through-hole 211f in upper surface 211d of lower cross 211.

Collar member 213 is disposed to guide (protect) bolt 800. This can suppress bolt 800 and power storage module 100 from being brought into contact due to vibrations.

Moreover, since lower end 213b of collar member 213 is in contact with extending ridge 212h of lower cover 210, a force that is applied to extending ridge 212h due to the impact from below can be distributed to lower cross 211 and collar member 213. This can reduce the stress applied to a contact surface between lower cross 211 and extending ridge 212h, as compared to lower cover 210 without collar member 213. For example, this can suppress the portion of extending ridge 212h below the lower cross 211 from receding (depressing) upward.

Upper surface 211d of lower cross 211 and an outer periphery 213d of collar member 213 are joined together by arc welding, for example. Specifically, a Z1-side surface 211g of upper surface 211d of lower cross 211 and outer periphery 213d of collar member 213 are welded. A welded portion 211h at which the surface 211g and outer periphery 213d are welded may be formed in an annular shape surrounding collar member 213 as viewed from the Z1 side.

### <Method of Removal of Lower Cover>

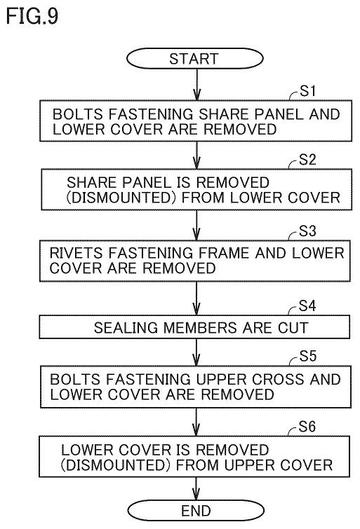

Next, referring to FIG. 9, an example of a method of removal of lower cover 210 is now described. In step S1, bolts 700 fastening share panel 230 and lower cover 210 (bottom plate 212) are removed. In step S2, share panel 230 is removed (dismounted) from lower cover 210. In step S3, rivets 600 and 610 fastening frame 300 and lower cover 210 are removed. In step S4, sealing members 500 and 510 are cut by a cutter or the like. In step S5, bolts 800 fastening upper cross 221 and lower cover 210 (bottom plate 212) are removed. In step S6, lower cover 210 is removed (dismounted) from upper cover 220 (upper cross 221). This removes lower cover 210, while power storage module 100 is being held by upper cover 220.

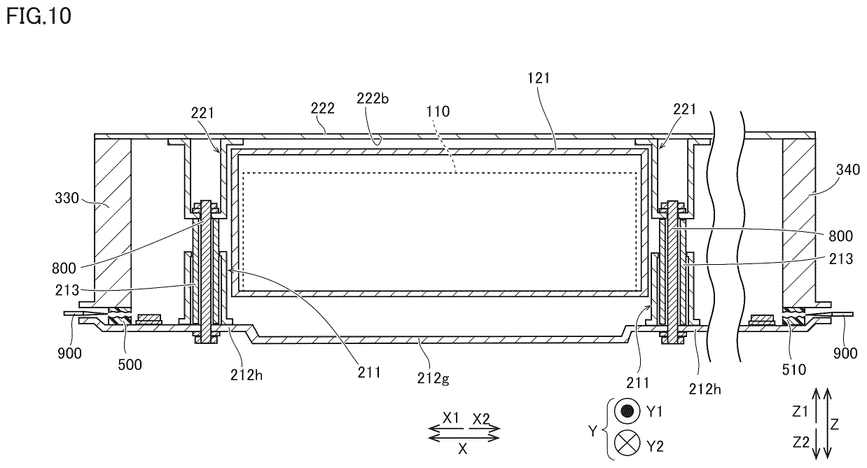

FIG. 10 is a diagram showing step S4 of FIG. 9. In FIG. 10, sealing members 500 and 510 are each divided into two in the up-down direction by a cutter 900.

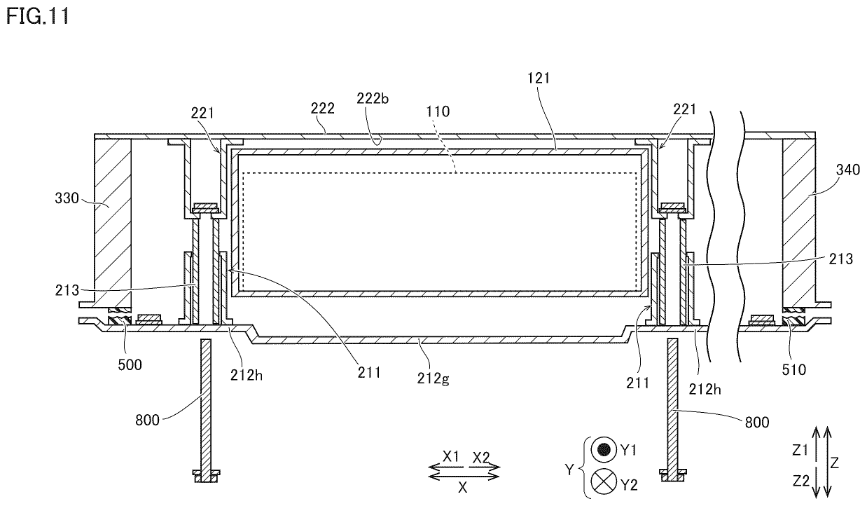

FIG. 11 is a diagram showing step S5 of FIG. 9. In this step, bolts 800 are unscrewed from collar members 213 from below.

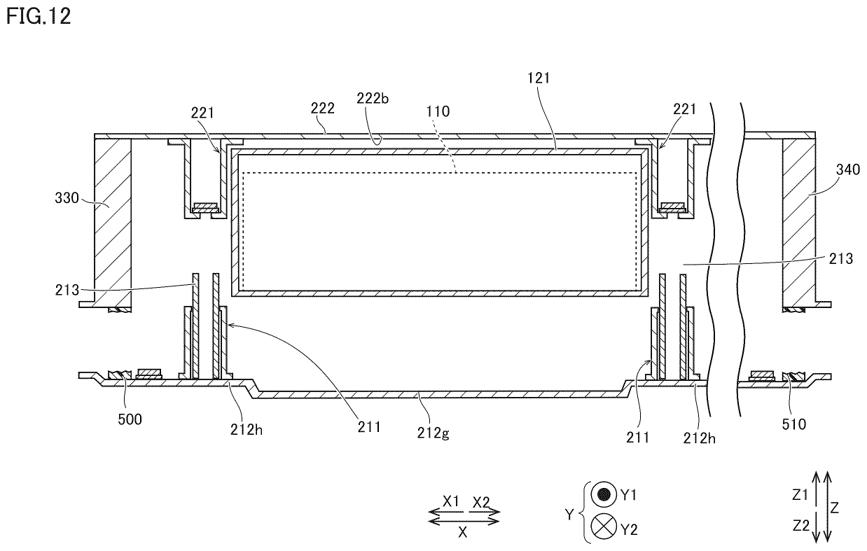

FIG. 12 is a diagram showing step S6 of FIG. 9. In this step, lower cover 210 (bottom plate 212, lower cross 211) is moved downward.

As described above, in the present embodiment, power storage module 100 is secured to upper cover 220, and lower cover 210 is detachably secured to upper cover 220. This allows power storage module 100 to be held by upper cover 220, thereby preventing power storage module 100 from being dismounted from vehicle 10 when lower cover 210 is removed from upper cover 220. As a result, lower cover 210 can be readily removed. Moreover, this allows repairing or exchanging of lower cover 210, without requiring dismounting of power storage module 100 from vehicle 10.

Moreover, in the present embodiment, in the region where case 200 overlaps with power storage module 100 in Z direction, distance D3 in Z direction between lower cover 210 and share panel 230 is less than distance D2 in Z direction between lower cover 210 and power storage module 100. This can readily allow an increased space between lower cover 210 and power storage module 100, allowing the space for evacuating smoke out of power storage module 100 and the space for absorbing the impact from below to be common. As a result, as compared to providing these two spaces separately, vehicle 10 can have improved space efficiency.

In the above embodiment, the positions of connections 122 in Y direction on side 121a of upper cross 221 and the positions of connections 122 in Y direction on side 121b of upper cross 221 are the same. However, the present disclosure is not limited thereto. These positions may be different from each other.

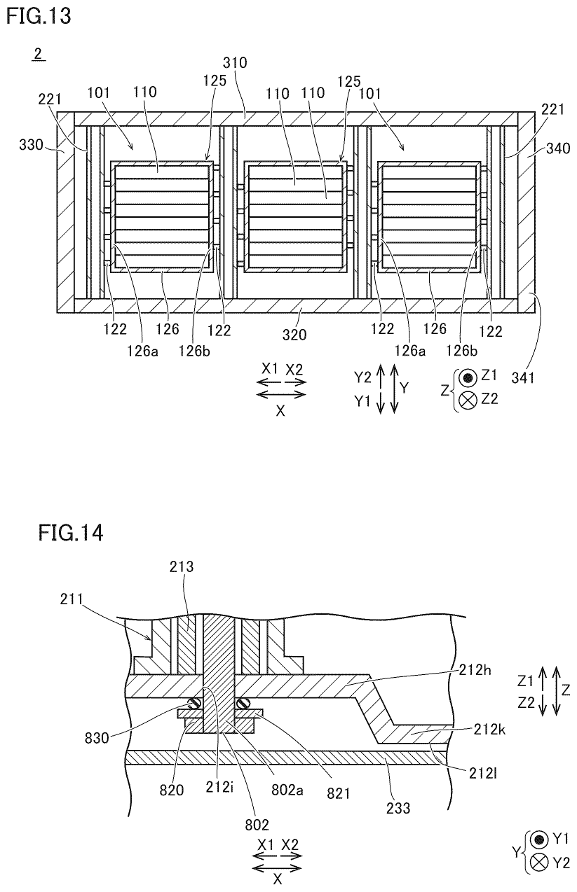

In the example of FIG. 13, power storage device 2 includes multiple power storage modules 101. Power storage modules 101 each include a cell case 125 accommodating power storage cells 110. Cell case 125 has a case body 126 and eight connections 122. Four of the eight connections 122 project from the X1-side side 126a of case body 126 to the X1 side. The remaining four of the eight connections 122 project from the X2-side side 126b of case body 126 to the X2 side.

The four connections 122 of side 126a and the four connections 122 of side 126b are disposed at different locations (coordinates) in Y direction. In other words, the four connections 122 on side 126a are not disposed at the same positions in Y direction with the four connections 122 on side 126b.

With this configuration, unlike the above embodiments, power storage modules 101 have the same orientation in Y direction. This prevents the contact between connections 122 between power storage modules 101 that are adjacent to each other in X direction.

In the above embodiment, lower cover 210 (bottom plate 212) is fastened to upper cover 220 (upper cross 221) with bolts 800. However, the present disclosure is not limited thereto. The lower cover may be secured to the upper cover with adhesives. For example, in a configuration where the outer periphery of the bottom plate of the lower cover and the outer periphery of the top panel of the upper cover are disposed adjacent to each other in Z direction, the outer peripheries may be adhered to each other with adhesives. Alternatively, the upper cross may be formed to extend to the bottom of the lower cover plate, and the upper cross and the bottom plate may be adhered to each other with adhesives. Alternatively, bottom plate 212 of lower cover 210 and top panel 222 of upper cover 220 may be fastened with bolts.

In the above embodiment, power storage module 100 (connections 122) and upper cover 220 (upper cross 221) are fastened by bolts 400. However, the present disclosure is not limited thereto. Connections 122 may be secured to upper cross 221 with adhesives. Moreover, power storage modules 100 may be secured to top panel 222 of upper cover 220. In this case, the upper cover may not be provided with upper cross 221.

In the above embodiment, power storage device 1 is provided with share panel 230. However, the present disclosure is not limited thereto. The power storage device may not be provided with share panel 230. In this case, a coating may be applied to the undersurface of bottom plate 212 of lower cover 210.

In the above embodiment, thickness t1 of lower cover 210 (bottom plate 212) is greater than thickness t2 of share panel 230, and lower cover 210 (bottom plate 212), thereby, has higher rigidity than share panel 230. However, the present disclosure is not limited thereto. The lower cover may be formed of a material that has higher rigidity than the share panel. Moreover, beads may be formed on the lower cover to provide rigidity to the lower cover higher than the rigidity of the share panel. Moreover, the rigidity of the lower cover and the rigidity of the upper cover may be the same as these variations.

In the above embodiment, share panel 230 is detachably secured to lower cover 210. However, the present disclosure is not limited thereto. Share panel 230 may be non-detachably secured to lower cover 210 by welding, for example.

In the above embodiment, upper cross 221 extends downward from top panel 222. However, the present disclosure is not limited thereto. The upper cross may not extend downward from top panel 222. For example, the lower end of the upper cross may be located above the power storage module.

Lower cover 210 (bottom plate 212) and frame 300 (wall 330 and wall 340) are secured below the power storage modules 100. However, the present disclosure is not limited thereto. Lower cover 210 (bottom plate 212) and frame 300 (wall 330 and wall 340) may be secured at the same position as or above the bottom 123 of power storage module 100 in Z direction.

In the above embodiment, ends 802 of bolts 800 are disposed at the same position in Z direction as the undersurface 212j (FIG. 8) of bottom 212g of lower cover 210. However, the present disclosure is not limited thereto. As shown in FIG. 14, ends 802 may be located above an undersurface 212l of a bottom 212k. Note that bottom 212k and undersurface 212l are one example of a “cover body” and an “undersurface,” respectively, according to the present disclosure.

In the above embodiment, multiple extending ridges 212h are aligned in Y direction (FIG. 7). However, the present disclosure is not limited thereto. A single extending ridge may extend in Y direction below the lower cross 211. For example, the extending ridges may extend from the Y1-side end of lower cross 211 to the Y2-side end of the lower cross 211 in Y direction.

In the above embodiment, power storage device 1 is disposed on under body 11a of vehicle 10. However, the present disclosure is not limited thereto. Power storage device 1 may be disposed on the bottom of an electrical equipment (e.g., a stationary power storage device), other than the vehicle.

In the above embodiment, lower cover 210 (bottom plate 212) and frame 300 (the walls 330 and 340) are secured by sealing member 500 (510) and rivet 600 (610). However, the present disclosure is not limited thereto. For example, the sealing members may not have adhesion properties, and lower cover 210 and frame 300 may be secured with fastener members only. In this case, the sealing members may be provided in the vicinities of (adjacent to) the fastener members.

In the above embodiment, frame 300 is configured of four walls (310, 320, 330, and 340). However, the present disclosure is not limited thereto. For example, the frame may be formed of a single plate-like member having a frame shape. Moreover, two L-shape plate-like members may be combined.

Note that the above embodiment and various variations thereof may be combined.

### Reference Example

The above embodiment and various variations thereof illustrate the lower cover as being detachably secured to the upper cover. In contrast, it is contemplated that the lower cover is detachably secured to the power storage module. Even in this case, the lower cover can be removed, without removing the power storage modules.

While the embodiment and variations thereof according to the present disclosure has been described above, the presently disclosed embodiment should be considered in all aspects illustrative and not restrictive. The scope of the present disclosure is defined by the appended claims. All changes which come within the meaning and range of equivalency of the appended claims are to be embraced within their scope.

What is claimed is:

1. A power storage device, comprising:
a power storage module including a plurality of power storage cells; and
a case accommodating the power storage module, wherein
the case includes:
a first cover covering the power storage module from above; and
a second cover covering the power storage module from below, wherein
the power storage module is secured to the first cover, and
the second cover is detachably secured to the first cover.

2. The power storage device according to claim 1, further comprising
a third cover below the second cover, wherein
the second cover has higher rigidity than the third cover.

3. The power storage device according to claim 2, wherein
the third cover is detachably secured to the second cover from below.

4. The power storage device according to claim 2, wherein
in a region where the case overlaps with the power storage module in an up-down direction, a distance in the up-down direction between the second cover and the third cover is less than a distance in the up-down direction between the second cover and the power storage module.

5. The power storage device according to claim 1, wherein
the first cover includes:
a top panel above the power storage module; and
a securing unit on the top panel, wherein
the power storage module is secured to the securing unit, and
the second cover is secured to the securing unit from below.

6. The power storage device according to claim 5, wherein
the securing unit extends downward from the top panel.

7. The power storage device according to claim 5, further comprising:
a frame member surrounding the securing unit and the power storage module; and
a sealing member sealing between the frame member and the second cover, wherein
the first cover and the second cover are secured to the frame member, and
the sealing member is disposed in a vicinity where the second cover is secured to the frame member.

8. The power storage device according to claim 7, wherein
the second cover is secured to the frame member below the power storage module.

9. The power storage device according to claim 5, further comprising
a fastener member fastening the second cover and the securing unit, wherein
the second cover includes:
a cover body; and
an extending ridge receding upward from the cover body, wherein
the fastener member fastens the extending ridge and the securing unit.

10. The power storage device according to claim 9, wherein
the fastener member is disposed so as to have a lower end located at the same position as or above an undersurface of the cover body in the up-down direction.

11. The power storage device according to claim 1, wherein
the second cover has higher rigidity than the first cover.

12. The power storage device according to claim 1, wherein
in a region where the case overlaps with the power storage module in an up-down direction, a distance in the up-down direction between the first cover and the power storage module is less than a distance in the up-down direction between the second cover and the power storage module.

13. A vehicle, comprising:
a vehicle body; and
the power storage device according to claim 1 secured to a bottom of the vehicle body.
